(19) United States
(12) Patent Application Publication
(10) Pub. No.: US 2026/0276167 A1
(43) Pub. Date: Sep. 17, 2026

(54) LIGHTING DEVICE FOR A MOTOR VEHICLE

(71) Applicant: HELLA GMBH & CO. KGAA, Lippstadt (DE)

(72) Inventor: Martin Mügge, Geseke (DE)

(21) Appl. No.: 19/560,915

(22) Filed: Mar. 9, 2026

(30) Foreign Application Priority Data
Mar. 13, 2025 (DE) 102025109552.3

(51) Int. Cl. F21S 43/239; F21S 43/14; F21S 43/15; F21S 43/20

(52) U.S. Cl. CPC F21S 43/239; F21S 43/14; F21S 43/15; F21S 43/26241; F21S 43/265

(57) ABSTRACT

A lighting device for a motor vehicle is provided. The lighting device includes a light source and a planar light guide having two large surfaces opposite one another and a plurality of narrow end faces. The light guide has an entry surface that is formed on one of the end faces, and first and second exit surfaces that are formed on the large surfaces and lie opposite one another. The lighting device further includes a first optical component configured to be reflective. Light generated by the light source enters the light guide at through the entry surface, exits at least partially from the first exit surface, is at least partially reflected by the first optical component, the reflected light re-enters the light guide at least partially through the first exit surface, and the light that has re-entered the light guide exits at least partially from the second exit surface.

### CROSS-REFERENCE TO RELATED APPLICATIONS

This application claims the benefit of German Patent Application 10-2025-109-552.3, filed Mar. 13, 2025, the disclosure of which is incorporated by reference in its entirety.

### FIELD OF THE INVENTION

The present invention relates to a lighting device for a motor vehicle.

### BACKGROUND OF THE INVENTION

Design has long been a determining factor for the signal functions of a motor vehicle such as a tail light, a brake light, a turn signal, or a daytime running light in rear lamps or in headlamps. The design of these lighting devices has become even more important since the introduction of LED technology, because the small light-emitting diodes, which are often used in larger numbers, can be used as a light source for a signal function much more flexibly than a large incandescent lamp, so that a wide variety of design options is provided in conjunction with the selected optical system.

A variant of LED technology is found in the form of OLED technology in which the light source is not small and point-like as a light-emitting diode, but rather is designed to be planar and larger to form a desired luminous surface that can be illuminated very homogeneously. A disadvantage of OLED technology is the significantly higher cost of OLED technology compared to LED technology. The reasons for these high costs are a complex manufacturing process, the different shapes dictated by the design and small quantities. In addition, there are specific, stringent requirements in the automotive sector, such as resistance to UV exposure and the effects of forces such as vibrations, impacts and shaking, as well as temperature resistance in a range between −40° C. and +85° C. or +100° C. These requirements are much more difficult to meet for an organic light-emitting diode than for standard light-emitting diodes.

As a result, alternative options are being sought to achieve a design similar to that of organic light-emitting diodes (OLED), in particular a homogeneously illuminated surface. This is achieved by using light-emitting diodes (LEDs) with a planar light guide and upstream optics in the form of microstructured films or thin optical plates to scatter the light emitted from the light guide. Overall, this provides a flat light module that offers high performance with homogeneous illumination of the entire surface.

Just as with organic light-emitting diodes, several flat light modules can then be positioned offset next to and behind each other when integrated into a combination rear lamp, in order to create the desired individual appearance of the signal function, for example the tail light or the tail/brake light. Finally, a flat light module can also be designed as a large planar luminous element instead of individual modules. As such a planar lighting device, it can also be used to backlight displays.

A lighting device of the type mentioned at the beginning, designed as a flat light module, is known from DE 10 2023 116 680 A1. The lighting device described therein comprises at least one light source designed as a light-emitting diode (LED) and a planar light guide with an entry surface and at least one exit surface, wherein the entry surface is designed as an end face of the light guide. The lighting device further comprises at least one optical plate. The lighting device is configured such that the light generated by the at least one light source enters the light guide at least partially through the entry surface, so that the light that has entered through the entry surface exits at least partially from the at least one exit surface and so that the light exiting from the at least one exit surface of the light guide passes at least partially through the at least one optical plate. In this case, the flat light module can have LEDs of different colors such as red, yellow, or white in order to achieve a combination of signal functions, such as a tail/brake/turn signal light or an additional reversing light.

An exemplary lighting device designed as a flat light module according to this prior art is shown in FIG. 8 to FIG. 10. This flat light module comprises a light source 1 that has several light-emitting diodes (LEDs). The flat light module also comprises a housing 2 with a rear housing part and a front housing part 2a, 2b that are connected to one another by a latching mechanism. A plate-shaped light guide 3 with micro-optics, an optical component 4 configured as a white diffusely reflective film behind the light guide 3, and two or three optical components 5a, 5b designed as micro-optical films in front of the light guide 3 are inserted between the housing parts 2a, 2b, which together are responsible for the light distribution and efficiency of the system in that the individual micro-optical components are matched to one another. The principle of this basic structure is to provide a luminous element with a uniformly homogeneously illuminated surface. For this purpose, the lighting device comprises a cover lens 6 that serves as the illuminated exit surface of the lighting device.

The optical component 5a adjacent to the light guide 3 is designed as a diffuser, whereas the optical component 5b is designed as a so-called BEF optic. BEF in this context means “Brightness Enhancement Film”. The BEF optic therefore serves to increase the brightness of the light passing through the optical component 5b. For this purpose, the BEF optic can be realized on a film or also as a thin injection-molded optical plate. Systems with two BEF optics aligned orthogonally to each other can also be provided, wherein the diffuser optic is sometimes dispensed with.

The light guide 3 has an upper end-face entry surface (not shown) as well as a first exit surface 3a shown on the left in FIG. 9 and a second exit surface 3b shown on the right in FIG. 9. The reflective optical component 4 is bent at the edges, so that the reflective optical component 4 has a first section 4a that is aligned parallel to the exit surfaces 3a, 3b of the light guide 3 and a plurality of second sections 4b that are parallel to the end faces of the light guide 3. This covers the first exit surface 3a of the light guide 3 as well as the lateral edges and the end faces of the light guide 3 in order to reflect any light that exits back into the light guide 3.

FIG. 10 shows an example of such a lighting device in which it can be seen that the narrow second sections 4b of the optical component 4 are each interrupted at the bending edges of the contour of the light guide 3 in order to be configured as angled film elements starting from the rear planar film surface. Due to these interruptions in the covering of the end faces of the light guide 3, light can exit in an uncontrolled manner and reduce the performance of the lighting device. In particular, when the contour or outline of the light guide 3 has an at least partially round and/or curved shape and/or a complex shape with a plurality of adjacent sections that include angles not equal to 90° and not equal to 270°, it proves to be pointless or even impossible to cover the end faces of the light guide 3 with the angled sections 4b of the optical component 4.

### SUMMARY OF THE INVENTION

The problem underlying the present invention is the creation of a lighting device of the type mentioned at the beginning that also has good performance even when the light guide is round and/or curved and/or complex in at least some sections.

This is achieved by a lighting device of the type mentioned at the beginning with the characterizing features of current embodiments of the present invention.

In one embodiment, it is provided that the lighting device comprises a second optical component that is configured to be reflective, is separate from the first optical component and is arranged at least partially on the end faces that are different from the entry surface. The lighting device can be configured such that the light entering the light guide through the entry surface exits at least partially from the light guide through the end faces that are different from the entry surface, that the light exiting from the end faces of the light guide is at least partially reflected by the second optical component, that the light reflected by the second optical component enters the light guide at least partially through the end faces, and that the light that has re-entered the light guide exits at least partially from the second exit surface. The second optical component can have a largely uninterrupted course, such that no light can exit in an uncontrolled manner at the bending edges of the contour of the light guide. As a result, the performance of the lighting device is not weakened as in the described prior art.

It is possible for the planar light guide in the plane formed by the first and the second direction to have an outline that deviates from a rectangular shape, in particular wherein the outline of the planar light guide in the plane formed by the first and the second direction has an at least partially round and/or curved shape and/or a complex shape with a plurality of adjacent sections that include angles not equal to 90° and not equal to 270°. The second optical component can be adapted to the outline of the planar light guide in the plane formed by the first and the second direction, such that the second optical component rests against the end faces that are different from the entry surface. The design of the second optical component that follows the outline or contour of the end faces of the light guide ensures almost complete back-reflection of the light exiting from the end faces, in particular also of the light exiting from the regions around the bent edges.

It may be provided that the sections of the second optical component that abut the end faces other than the entry surface are configured to be reflective, in particular are mirror-coated by vapor deposition with a reflective layer. The second optical component can be an injection-molded part, in particular an injection-molded part made of a diffusely reflective plastic. In particular, this plastic can be configured to be rigid or non-elastic.

It is possible that the lighting device comprises at least one third optical component that is designed as a microstructured film and/or as a microstructured optical plate, wherein the lighting device is configured such that light exiting from the second exit surface passes through the at least one third optical component before it leaves the lighting device. The third optical component can help to shape the light, in particular to homogenize the light exiting from the lighting device.

It is further possible that the lighting device comprises a cover lens, wherein the lighting device is configured such that light exiting from the second exit surface exits from the lighting device through the cover lens, in particular wherein the at least one third optical component is arranged between the light guide and the cover lens. The cover lens can be provided with a structuring such as a diffuser optic, for example, so that the cover lens can also contribute to light shaping, in particular to homogenization of the light.

It may be provided that the second optical component has an edge extending at least in sections around the circumference that is designed in such a way that in the assembled state of the lighting device it bears against the surface of the at least one third optical component that faces away from the light guide. This means that the second optical component can simultaneously serve as a retaining element for the at least one third optical component that is configured, for example, as a film.

It is possible that the lighting device comprises two third optical components that are designed as microstructured films and/or as microstructured optical plates, wherein the lighting device is configured such that light exiting from the second exit surface passes through the two third optical components one after the other. The several third optical components together can ensure a desired light scattering and, thus, homogeneous illumination of the exit surface.

It may be provided that one of the third optical components is designed as a diffuser. A diffuser optic allows the light to be suitably scattered.

It is possible that one of the third optical components has an array of roof prisms. This creates a BEF optic. BEF in this context means “Brightness Enhancement Film”. The BEF optic is used to increase the brightness of the light passing through the optical component.

It may be provided that the lighting device comprises a housing in which the light guide and the optical components are arranged, wherein the housing in particular has a front and a rear housing part that are connected to one another by a latching mechanism. This allows the optical components to be held securely.

Furthermore, it may be provided that the light source comprises a plurality of light-emitting diodes that are arranged next to each other in the direction of the longitudinal extension of the entry surface. This means that the entire width of the light guide can be illuminated.

### BRIEF DESCRIPTION OF THE DRAWINGS

The invention is explained in more detail below with reference to the accompanying figures. In the figures:

FIG. 1 is a side view of a detail of an exemplary embodiment of a lighting device according to an embodiment of the invention;

FIG. 2 is a perspective view of the detail of the lighting device according to FIG. 1 with two third optical components;

FIG. 3 is a further perspective view of the detail of the lighting device according to FIG. 1 with a first optical component and two third optical components;

FIG. 4 is an exploded view of the detail according to FIG. 3;

FIG. 5 is an exploded perspective view of the detail of the lighting device according to FIG. 1 with a first optical component, a second optical component and two third optical components;

FIG. 6 is a perspective view of the detail according to FIG. 5;

FIG. 7 is a further perspective view of the detail according to FIG. 5;

FIG. 8 is a perspective view of a lighting device according to the prior art;

FIG. 9 is an exploded view of the lighting device according to FIG. 8; and

FIG. 10 is an example of a detail of the lighting device according to FIG. 8 in an exploded view.

In the figures, identical or functionally identical parts are marked with the same reference symbols. For easier orientation, a Cartesian coordinate system is shown in some of the figures.

### DETAILED DESCRIPTION

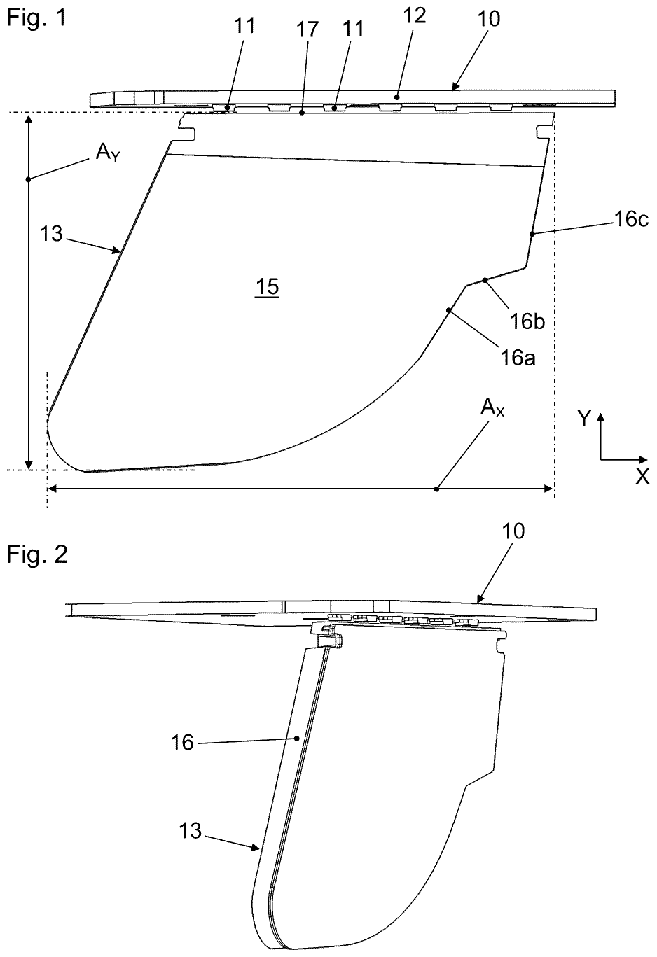

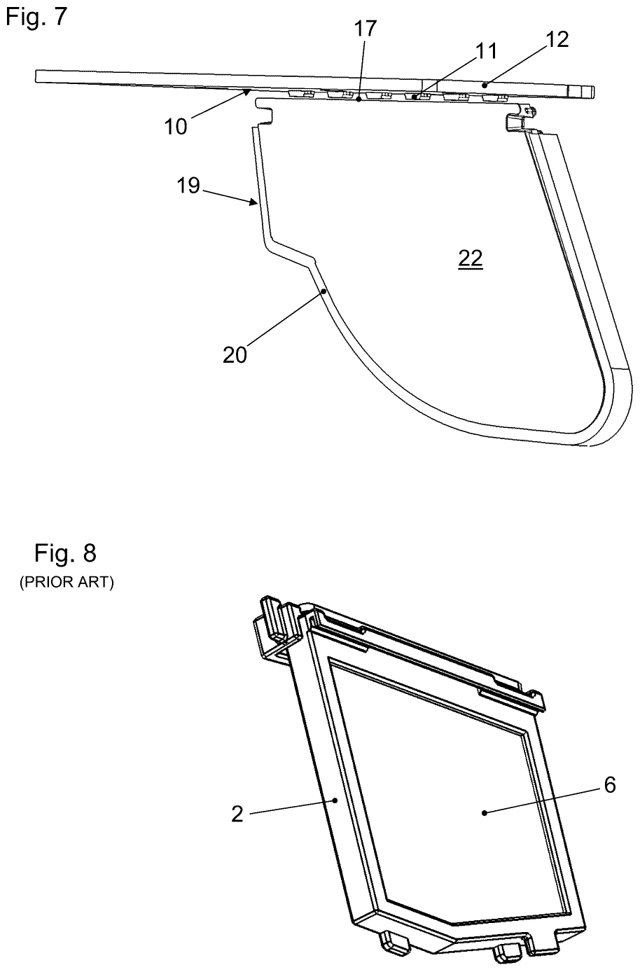

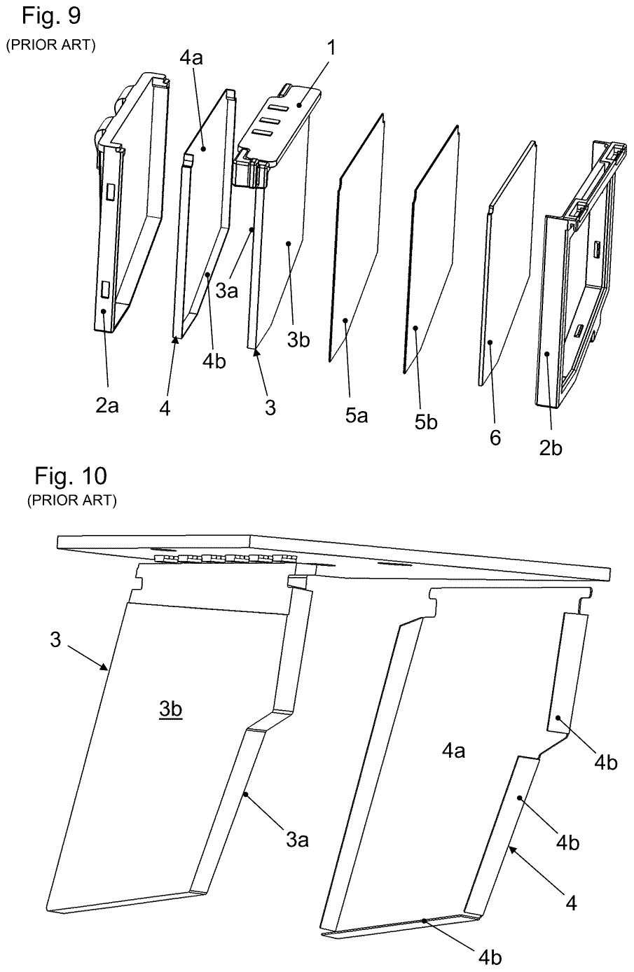

The lighting device shown in FIG. 1 to FIG. 7 comprises a light source 10 which has a plurality of light-emitting diodes (LEDs) 11. The plurality of light-emitting diodes 11 are arranged on a printed circuit board 12 of the light source 10. In particular, the printed circuit board 12 can be provided with a white solder resist in order to reflect light that is reflected back in the system back to the front.

The multiple light-emitting diodes 11 can also have different colors, for example, to implement a dual function or a triple function. For example, light-emitting diodes 11 with red and yellow, or white and yellow, or white and cyan, or bi-color LEDs, or RGB LEDs are possible. The functions can be, for example, a position light, a daytime running light and a turn signal, or a position light, a daytime running light and an autonomous driving function, wherein the autonomous driving function requires a cyan color.

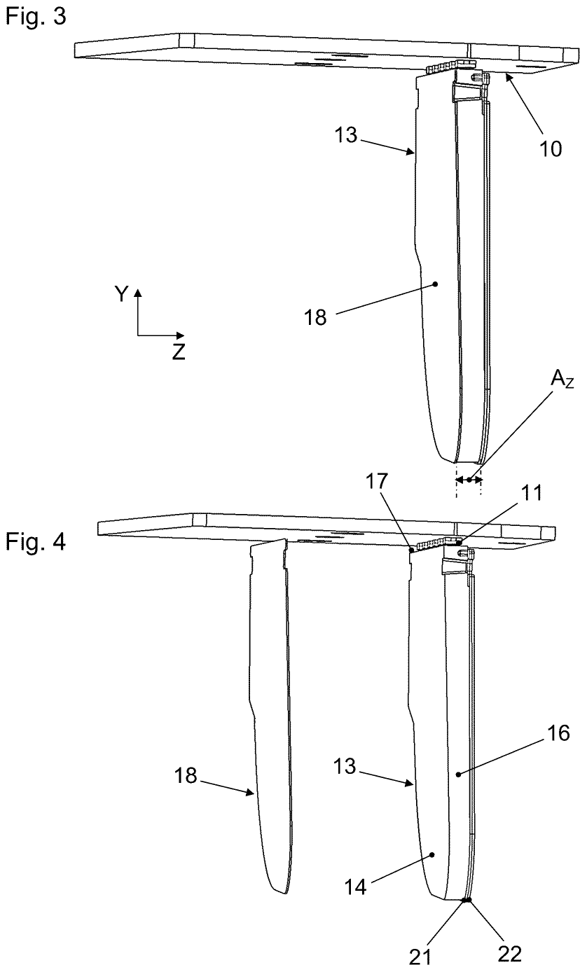

The lighting device further comprises a planar light guide 13. The light guide 13 has an extent A_{X}, A_{Y} in a first direction X and in a second direction Y perpendicular to the first direction X that is significantly greater than the extent A_{Z} of the light guide 13 in a third direction Z that is perpendicular to the first direction X and to the second direction Y (see FIG. 1 and FIG. 3). As a result, the light guide 13 has two opposing large surfaces serving as exit surfaces 14, 15 and a plurality of narrow end faces 16, wherein the upper one of the end faces in FIG. 1 serves as an entry surface 17. The large surface shown on the left in FIG. 3 and FIG. 4 serves as the first exit surface 14 and the large surface shown on the right in FIG. 3 and FIG. 4 that is not visible serves as the second exit surface 15.

In the X-Y plane formed by the first and second direction X, Y, the planar light guide has an outline that deviates from a rectangular shape (see FIG. 1). The outline of the light guide 13 or the contour of the narrow end faces 16 in the X-Y plane has a round or curved shape in some sections and a shape with a plurality of adjacent sections 16a, 16b, 16c of the end faces 16 that enclose angles not equal to 90° and not equal to 270°.

The lighting device further comprises a first optical component 18 (see FIG. 3 and FIG. 4) that is configured to be reflective. The first optical component 18 is designed as a planar reflective optical film, wherein the reflective surface in particular has a white surface in order to diffusely reflect the light back. In the assembled state of the lighting device, the first optical component 18 abuts the first exit surface 14 of the light guide 13. The first optical component 18 has in the X-Y plane a contour that is the same as the contour of the light guide 13 in the X-Y plane. If the first optical component 18 is formed as a film, the corresponding contour can be realized simply by cutting, punching or laser cutting.

The lighting device is configured such that the light generated by the light source 10 enters the light guide 13 at least partially through the entry surface 17, that the light entering through the entry surface 17 exits at least partially from the first exit surface 14, that the light exiting from the first exit surface 14 of the light guide 13 is at least partially reflected by the first optical component 18, that the reflected light enters the light guide 13 at least partially through the first exit surface 14, and that the light re-entering the light guide 13 exits at least partially from the second exit surface 15.

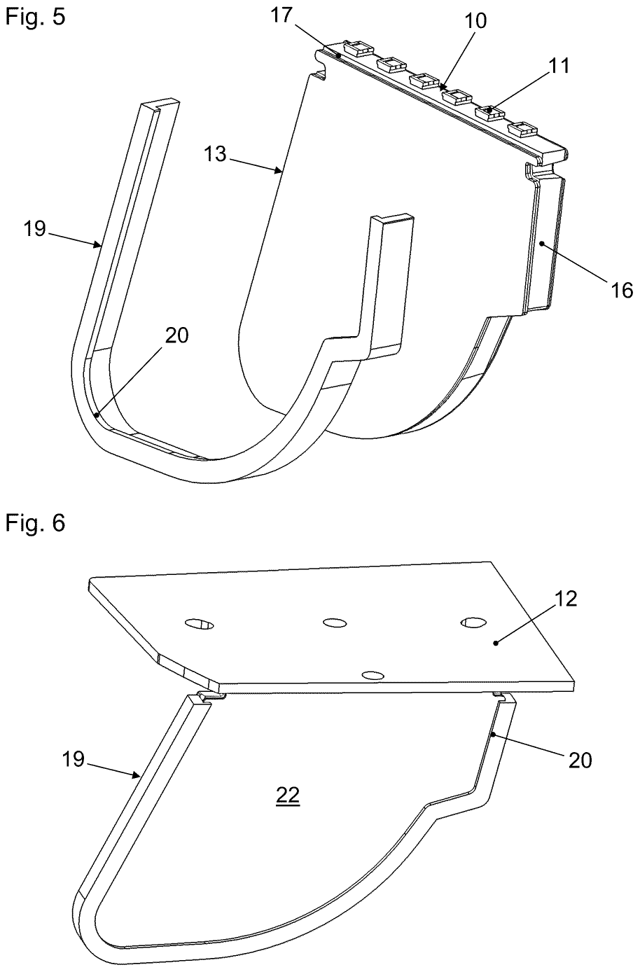

The lighting device further comprises a second optical component 19 (see FIG. 5 to FIG. 7) that is also configured to be reflective. The second optical component 19 is adapted to the outline or the contour of the narrow end faces 16 of the planar light guide 13 in the X-Y plane, such that in the assembled state of the lighting device the second optical component 19 abuts the end faces 16 that are different from the entry surface 17. In particular, the sections of the second optical component 19 that abut the end faces 16 that are different from the entry surface 17 are configured to be reflective, for example, are mirror-coated by vapor deposition with a reflective layer.

The second optical component 19 is manufactured as an injection-molded part separate from the first optical component 18, in particular as an injection-molded part made of a diffusely reflective plastic. In particular, this plastic can be configured to be rigid or non-elastic. The second optical component 19 has an edge 20 extending at least in sections around the circumference, the function of which is explained in more detail below.

The lighting device is configured such that the light entering the light guide 13 through the entry surface 17 exits at least partially from the light guide 13 through the end faces 16 that are different from the entry surface 17, that the light exiting from the end faces 16 of the light guide 13 is at least partially reflected by the second optical component 19, that the light reflected by the second optical component 19 enters the light guide 13 at least partially through the end faces 16, and that the light that has re-entered the light guide 13 exits at least partially from the second exit surface 15.

The lighting device further comprises two third optical components 21, 22 arranged in front of the second exit surface 15 of the light guide 13 (see, for example, FIG. 3 and FIG. 4). One of the two third optical components 21, 22 is optional and can also be omitted. The third optical components 21, 22 can be designed as microstructured films and/or as microstructured optical plates. The lighting device is configured such that light exiting from the second exit surface 15 passes through the two third optical components 21, 22 one after the other. The third optical components 21, 22 also have a contour in the X-Y plane that is the same as the contour of the light guide 13 in the X-Y plane. If the third optical components 21, 22 are formed as films, the corresponding contour can be realized simply by cutting, punching or laser cutting.

In the illustrated exemplary embodiments, the third optical component 21 adjacent to the second exit surface 15 of the light guide 13 has a diffuser optic. This diffuser optic can be arranged on the entry surface and/or on the exit surface of this third optical component 21.

The other of the two third optical components 22 has a BEF optic in the illustrated exemplary embodiments. It is certainly possible to alternatively or additionally arrange a BEF optic on the entry surface of this third optical component 22.

FIG. 6 illustrates that the edge 20 extending around the circumference of the second optical component 19 is designed in such a way that in the assembled state of the lighting device it abuts the surface of the outer one of the two third optical components 21, 22 that faces away from the light guide 13. This means that the second optical component 19 can simultaneously serve as a retaining element for the two third optical components 21, 22 that are configured in the form of a film, for example.

It is also possible that the lighting device comprises a cover lens (not shown), wherein the lighting device is configured such that light exiting from the second exit surface exits the lighting device through the cover lens after passing through the two third optical components 21, 22. The cover lens can be provided with a structuring, such as a diffuser optic.

It is further possible that the lighting device comprises a housing (not shown), in which the light guide 13 and the optical components 18, 19, 21, 22 are arranged, wherein the housing in particular has a front and a rear housing part that are connected to one another by a latching mechanism.

### LIST OF REFERENCE SYMBOLS

1 light source
2 housing
2a, 2b housing part
3 light guide
3a first exit surface of the light guide
3b second exit surface of the light guide
4 optical component configured to be reflective
4a first section of the optical component configured to be reflective
4b second section of the optical component configured to be reflective
5a, 5b optical component configured as a micro-optical film
6 cover lens
10 light source
11 light-emitting diode
12 printed circuit board
13 planar light guide
14 first exit surface of the light guide
15 second exit surface of the light guide
16 end face of the light guide
16a, 16b, 16c section of the end face
17 entry surface of the light guide
18 first optical component
19 second optical component
20 edge of the second optical component
21, 22 third optical component
X first direction
Y second direction
Z third direction
A_{X} extent of the light guide in the X direction
A_{Y} extent of the light guide in the Y direction
A_{Z} extent of the light guide in the Z direction

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A lighting device for a motor vehicle, comprising
a light source;
a planar light guide that has an extent in a first direction and in a second direction perpendicular to the first direction, which is significantly greater than the extent of the light guide in a third direction that is perpendicular to the first direction and to the second direction, such that the light guide has two mutually opposing large surfaces and a plurality of narrow end faces, wherein the light guide has an entry surface that is formed on one of the end faces, and wherein the light guide has a first and a second exit surface that are formed on the large surfaces and lie opposite one another;
a first optical component configured to be reflective, wherein the lighting device is configured such that the light generated by the light source enters the light guide at least partially through the entry surface, that the light which has entered through the entry surface exits at least partially from the first exit surface, that the light exiting from the first exit surface of the light guide is at least partially reflected by the first optical component, that the reflected light enters the light guide at least partially through the first exit surface, and that the light which has re-entered the light guide exits at least partially from the second exit surface; and
a second optical component configured to be reflective that is separate from the first optical component and is arranged at least partially on the end faces that are different from the entry surface.

2. The lighting device according to claim 1, wherein the lighting device is configured such that the light entering the light guide through the entry surface exits at least partially from the light guide through the end faces that are different from the entry surface, that the light exiting from the end faces of the light guide is at least partially reflected by the second optical component, that the light reflected by the second optical component enters the light guide at least partially through the end faces, and that the light re-entering the light guide exits at least partially from the second exit surface.

3. The lighting device according to claim 1, wherein the planar light guide has an outline deviating from a rectangular shape in the plane formed by the first and the second direction, wherein the outline of the planar light guide in the plane formed by the first and the second direction comprises at least one of a partially round shape, a curved shape, and a complex shape comprising a plurality of adjacent sections that enclose angles not equal to 90° and not equal to 270° with one another.

4. The lighting device according to claim 1, wherein the second optical component is adapted to the outline of the planar light guide in the plane formed by the first and the second direction, such that the second optical component abuts the end faces that are different from the entry surface.

5. The lighting device according to claim 4, wherein the sections of the second optical component that abut the end faces that are different from the entry surface are configured to be reflective.

6. The lighting device according to claim 1, wherein the second optical component is an injection-molded part.

7. The lighting device according to claim 1, wherein the lighting device comprises at least one third optical component configured as a microstructured film, a microstructured optical plate, or both a microstructured film and a microstructured optical plate, wherein the lighting device is configured such that light exiting from the second exit surface passes through the at least one third optical component before the light leaves the lighting device.

8. The lighting device according to claim 1, wherein the lighting device further comprises a cover lens, wherein the lighting device is configured such that light exiting from the second exit surface exits from the lighting device through the cover lens.

9. The lighting device according to claim 8, wherein the at least one third optical component is arranged between the light guide and the cover lens.

10. The lighting device according to claim 7, wherein the second optical component has an edge extending at least in sections around the circumference that is configured such that in the assembled state of the lighting device it abuts the surface of the at least one third optical component that faces away from the light guide.

11. The lighting device according to claim 7, wherein the lighting device comprises two third optical components configured as microstructured films, as microstructured optical plates, or both as microstructured films and as microstructured optical plates, wherein the lighting device is configured such that light exiting from the second exit surface passes successively through the two third optical components.

12. The lighting device according to claim 11, wherein one of the third optical components is configured as a diffuser.

13. The lighting device according to claim 11, wherein one of the third optical components comprises an array of roof prisms.

14. The lighting device according to claim 1, wherein the lighting device comprises a housing in which the light guide and the optical components are arranged, wherein the housing comprises a front and a rear housing part that are connected to one another by a latching mechanism.

15. The lighting device according to claim 1, wherein the light source comprises a plurality of light-emitting diodes that are arranged next to one another in the direction of the longitudinal extent of the entry surface.
